(19) United States
(12) Patent Application Publication
(10) Pub. No.: US 2002/0053806 A1
(43) Pub. Date: May 9, 2002

(54) Front face with protective trim for a motor vehicle

(76) Inventors: Jean-Louis Lanard, Feucherolles (FR); Sebastien Guinehut, Paris (FR)

Correspondence Address: LINIAK, BERENATO, LONGACRE & WHITE, Suite 240, 6550 Rock Spring Drive, Bethesda, MD, 20817, US

(21) Appl. No.: 09/983,887

(22) Filed: Oct. 26, 2001

(30) Foreign Application Priority Data
Nov. 6, 2000 (FR) 00 14190

(51) Int. Cl. B60R 19/38

(52) U.S. Cl. 293/118

(57) ABSTRACT

A front face (10) for a motor vehicle comprises a protective trim (26) which is integral with the front face (10) via linking means (30, 32) allowing shifting of the protective trim between a position (P1) close to the front face and a position (P2) spaced away from the front face, which makes it possible to construct an assembly ready to be fitted. Application to motor vehicles.

### FIELD OF THE INVENTION

The invention relates to a front face for a motor vehicle, intended to accommodate a protective trim.

### BACKGROUND OF THE INVENTION

A front face, also called front facade, is a structural element capable of integrating various items of equipment of the vehicle, such as headlamps, flashing indicators, audible warning devices, heat exchanger, motor-driven fan unit or complete cooling module, etc.

The front face, thus provided with its equipment, constitutes a unit module prepared and delivered by the equipment manufacturer, ready to be mounted on the vehicle by the constructor. The mounting of this unit module takes place by connection to lateral structural elements of the vehicle, such as lengthwise side members, wings or body shell, then the fitting of a protective trim which is attached to the module.

Such a front face is generally produced in the form of a single-piece element, in particular in the form of a composite metal/plastic element. It is known, in fact, especially from the publication EP-A-0 658 470, to produce a front face in the form of a metal armature made from stamped sheet metal, over which a plastic is molded, particularly of the polyamide type. The protective trim is usually fixed onto a beam, called the bumper beam, which is itself carried by the front face.

In accordance with the existing solutions, the front face is first of all assembled on four fixing points, namely, generally, the two lower side members and the two upper side members of the vehicle. It is only then that the protective trim is fixed to the vehicle, generally by the use of screws situated in hidden locations, in particular in the arches for the front wheels of the vehicle.

Furthermore, the fixing of the protective trim requires screws passing through the protective trim in order to allow the front face to be fixed onto the side members, as well as removable blanking covers to leave access to the fixing of the front face onto the side members.

This results in the drawback that the protective trim has to possess blanking covers or trim pieces facing the side members.

Moreover, the fixing of the protective trim onto the front face, which is already assembled onto the vehicle, requires a certain number of operations which are hardly compatible with the restricted space available between two consecutive vehicles on an assembly line.

Up to the present, no solution has made it possible to deliver a complete front face thus allowing the front face and protective trim assembly to be fixed in a single operation onto the vehicle.

### SUMMARY OF THE INVENTION

The object of the invention is especially to overcome the abovementioned drawbacks.

To that end, the invention proposes a front face for a motor vehicle, of the type defined in the introduction, in which the protective trim is integral with the front face via linking means allowing shifting of the protective trim between a position close to the front face and a position spaced away from the front face.

It results therefrom that the front face delivered by the equipment manufacturer integrates the protective trim, in the sense that the latter is integral with the front face while being movable with respect to it. Such a characteristic makes it possible to assemble the front face although the protective trim is in its spaced-away position, then to shift the protective trim towards its close position so as to fix it permanently onto the structure of the vehicle.

During all these operations, the protective trim remains integral with the front face, which simplifies the fitting operations. It should be pointed out that this characteristic also offers the advantage of facilitating the transport of the front face, since the protective trim can be placed in its close position so as to limit the overall bulk of the front face and protective trim assembly.

In one preferred embodiment of the invention, the linking means comprise means of shifting in rotation.

Preferably, these rotational-shifting means comprise at least one articulation allowing the tilting of the protective trim about a transverse and horizontal axis of the vehicle, called Y axis.

It is advantageous for these rotational-shifting means to comprise two spaced coaxial articulations.

The linking means can be produced in another way. They may especially take the form of translational-shifting means, in particular with a slider.

According to another characteristic of the invention, the linking means are interposed between the protective trim and at least one support member integrated into the front face.

In one preferred embodiment, the support member is a transverse beam and especially a beam called “pedestrian beam” arranged below a bumper beam on which the protective trim has to be fixed in the close position.

It can be envisaged, however, to fix the linking means onto any other type of support member, as soon as this support member is integrated into the front face.

According to another characteristic of the invention, the front face further comprises means for temporary fixing of the protective trim onto the front face when the protective trim is in the close position.

These means make it possible to immobilize the protective trim on the front face, especially during transport of the front face, before assembly onto the vehicle.

These temporary fixing means can be chosen, for example, from a clip or a retaining lug.

According to yet another characteristic of the invention, the front face further comprises means for permanent fixing of the protective trim onto the front face when the protective trim is in its close position.

These permanent fixing means can be separate from the temporary fixing means, or else be coincident with them.

### BRIEF DESCRIPTION OF THE DRAWINGS

In the description which follows, given solely by way of example, reference is made to the attached drawings, in which:

FIG. 1 is a partial and diagrammatic side view of a motor vehicle equipped with a front face according to the invention, the protective trim of which is represented in the close position and in the spaced-away position;

FIG. 2 is an exploded view in perspective of a front face according to the invention before assembly onto a motor vehicle;

FIG. 3 is a detail on a larger scale of FIG. 2;

FIG. 4 is a partial view in perspective showing means for temporary fixing of the protective trim;

FIGS. 5, 6 and 7 show various embodiments of means of articulating the protective trim;

FIG. 8 shows another embodiment of temporary fixing means.

FIG. 9 shows another embodiment of means for articulating the protective trim.

### DETAILED DESCRIPTION OF THE PREFERRED EMBODIMENT

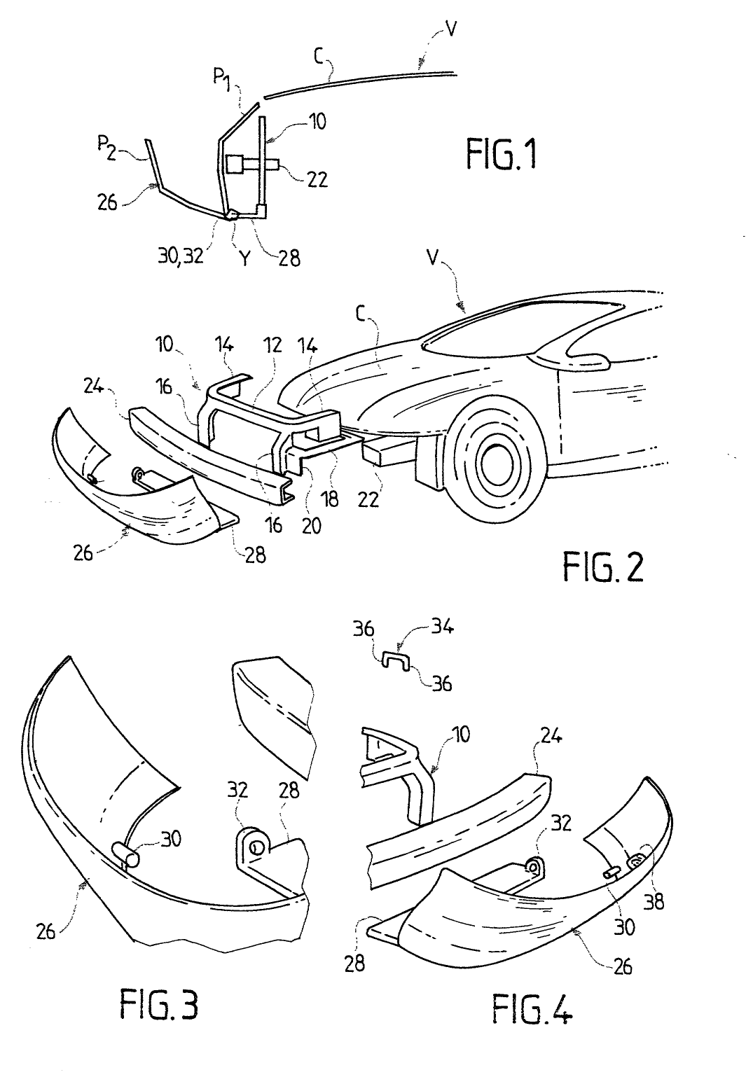

Referring jointly to FIGS. 1 and 2, a front face 10 is shown diagrammatically, suitable for being assembled onto the structure of a motor vehicle V, in front of the engine hood C thereof.

The front face 10, which is distinguished better in FIG. 2, comprises an upper crosspiece or beam 12 the ends 14 of which are intended to be fixed onto upper side members (not represented) of the vehicle.

The crosspiece 12 is produced in a single piece with two lateral uprights 16, also called legs, which are themselves joined to the extremities 14 of the crosspiece 12 by oblique reinforcements 18. The lateral uprights 16 comprise fixing plates 20 intended to be fixed onto lower side members 22 of the vehicle (FIGS. 1 and 2).

The front face constitutes a single-piece element which can be produced, in particular, in the form of a composite metal/plastic element, as taught, for example, by the publication EP-A-0 658 468 quoted above.

The front face 10 is equipped with a bumper beam 24 produced in the form of a profiled section, generally of metal material, having a generally U-shaped cross-section.

This bumper beam 24 is intended to accommodate a protective trim 26 capable of absorbing the frontal impacts on the vehicle. Such a protective trim is produced in the form of an element molded from reinforced plastic, the shape of which is designed partly to envelop the front of the vehicle and to provide effective protection against low-speed impacts.

In accordance with the invention, this protective trim 26 is integral with the front face 10 in such a way as to constitute a complete assembly ready to be fitted onto the vehicle.

To that end, the protective trim is integral with the front face via linking means which, in the embodiment of FIGS. 1 and 2, are a means for rotational movement. The protective trim 26 is articulated, at its lower part, onto a beam 28 provided at the lower part of the front face and arranged horizontally under the bumper beam 24. This beam 28 is called “pedestrian beam”.

As can be seen in FIGS. 1 to 3, the protective trim 26 is linked to the beam 28 by two coaxial articulations which extend along a transverse and horizontal axis, called Y axis.

In the example represented, and as shown in particular in FIG. 3, each of these articulations comprises a pivot-forming cylinder 30, integral with the protective trim 26, and a ring 32 integral with the front face, here with the beam 28. Thus, these two cylinders 30 come to engage in apertures defined by the rings 32 in order to allow the protective trim to tilt between two extreme position, namely a position close to the front face (position P1) and a position spaced away from the front face (position P2), as represented in FIG. 1.

The protective trim 26 can be held temporarily in its close position P1 by temporary fixing means, an embodiment example of which is represented in FIG. 4. These means here comprise a clip 34, in the shape of a staple, including two branches 36, one of which is suitable for being engaged in an appropriate aperture (not represented) forming part of the front face, and another of which is suitable for being engaged in a ring 38 formed on an inner face of the protective trim 26.

The front face of the invention is used in the following way. The front face is equipped beforehand with its protective trim so as to constitute a complete module delivered by the equipment manufacturer and ready to be mounted by the constructor.

For transport, the protective trim 26 is folded up into its close position P1, and is held in this position by temporary retention means, as represented, for example, in FIG. 4.

Next, the front face and protective trim assembly is fitted to the vehicle, by one or more operators or by robots.

To do that, the protective trim has first of all been tilted into its position spaced away from the front face so as to allow the front face to be fixed onto the upper side members and the lower side members of the vehicle.

During these operations, the protective trim is in its spaced-away position, which facilitates the fitting of the front face and of its equipment.

It is only then that the protective trim is tilted in the opposite direction into its close position in which it is applied against the bumper beam 24.

The protective trim is then fixed permanently onto the vehicle structure by conventional fixing means, which usually comprise screws placed at hidden locations on the vehicle.

Thus, the mounting of the front face and of the protective trim is greatly facilitated. This solution further offers the advantage that the protective trim can be easily installed, even if the space between two consecutive vehicles on an assembly line is restricted.

Referring now to FIG. 5, another embodiment is shown of the articulation means which are similar to those of FIG. 3. They comprise a cylinder 30 suitable for being engaged in a cylindrical housing 40 of a block 42 integral with the transverse beam 28.

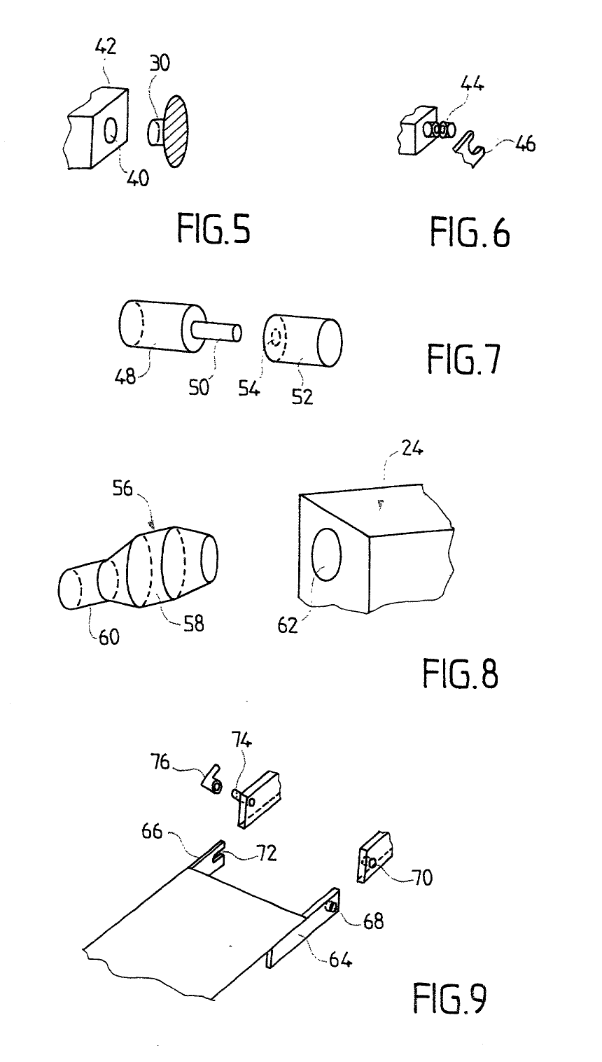

In the embodiment of FIG. 6, another embodiment of the articulation means is found. In this case, the beam 28 carries a cylinder 44 suitable for interacting with a forked part 46 which is integral with the protective trim.

In the embodiment of FIG. 7, the articulation means comprise two hinge parts, namely a hinge part 48 carrying a cylinder 50 and a hinge part 52 in which a cylindrical bore 54 is formed suitable for accommodating the cylinder 50. In the example, the hinge parts 48 and 52 are integral respectively with the protective trim 26 and with the transverse beam 24.

FIG. 8 shows another embodiment of temporary fixing means. These comprise a clip 56 integrated onto the protective trim 26. This clip possesses an axisymmetric shape with an end part 58 of substantially biconical shape linked to a linking part 60. The end part 58 is suitable for being force-fitted into a corresponding bore 62 formed in the bumper beam 24.

In the embodiment of FIG. 9, the temporary fixing means and the permanent fixing means are combined. The protective trim 26 includes two spaced-apart lugs 64 and 66. The lug 64 includes a hole 68 into which can be engaged a pivot 70 forming part of the front face, preferably of the transverse beam 28. The lug 66 is fork-shaped and comprises an open slot 72 suitable for accommodating another pivot 74 which is arranged axially with the pivot 70. A wing nut 76 makes it possible to lock the articulation of the lug 66 on the pivot 74.

The linking means allowing the protective trim to be shifted with respect to the front face, while remaining integral with it, are capable of numerous variants.

Thus, instead of using means for rotational movement, it is possible to envisage other types of movement means, especially translational movement means, in particular of the slider type.

It will be noted that the linking means do not need to possess high mechanical strength since they do not provide for the permanent fixing of the protective trim onto the front face.

The invention finds a general application to the front faces for motor vehicles, in particular for private vehicles.

What is claimed is:

1. Front face for a motor vehicle, intended to accommodate a protective trim, characterized in that the protective trim (26) is integral with the front face (10) via linking means (30, 32) allowing shifting of the protective trim between a position (P1) close to the front face and a position (P2) spaced away from the front face.

2. Front face according to claim 1, characterized in that the linking means comprise means of shifting in rotation (30, 32).

3. Front face according to claim 2, characterized in that the rotational-shifting means comprise at least one articulation (30, 32) allowing the tilting of the protective trim (26) about a transverse and horizontal axis (Y) of the vehicle.

4. Front face according to claim 3, characterized in that the rotational-shifting means comprise two coaxial articulations each comprising a cylinder (30) integral with the protective trim (26) engaged in a ring (32) of the front face (10).

5. Front face according to claim 1, characterized in that the linking means comprise means for translational shifting, in particular with a slider.

6. Front face according to claim 1, characterized in that the linking means (30, 32) are interposed between the protective trim (26) and at least one support member (28) integrated into the front face (10).

7. Front face according to claim 6, characterized in that the support member (28) is a transverse beam.

8. Front face according to claim 7, characterized in that the transverse beam (28) is a beam called “pedestrian beam” arranged below a bumper beam (24) on which the protective trim (26) has to be fixed in the close position (P1).

9. Front face according to claim 1, characterized in that it further comprises means (34; 56) for temporary fixing of the protective trim (26) onto the front face (10) when the protective trim is in the close position (P1).

10. Front face according to claim 9, characterized in that the temporary fixing means are chosen from a clip (34; 56) or a retaining lug.

11. Front face according to claim 1, characterized in that it further comprises means for permanent fixing of the protective trim (26) onto the front face (10) when the protective trim is in the close position (P1).

12. Front face according to claim 9, taken in combination, characterized in that the temporary fixing means (64, 66) and the permanent fixing means (64, 66) are combined.
